(19) United States
(12) Patent Application Publication
(10) Pub. No.: US 2002/0059167 A1
(43) Pub. Date: May 16, 2002

(54) Apparatus for saving files into a plurality of holders

(76) Inventor: Makoto Sunada, Yatsuo Machi (JP)

Correspondence Address: STAAS & HALSEY, Suite 500, 700 Eleventh Street, N.W., Washington, DC, 20001, US

(21) Appl. No.: 09/760,881

(22) Filed: Jan. 17, 2001

(30) Foreign Application Priority Data
Jul. 25, 2000 (JP) 2000-224192

(51) Int. Cl. G06F 7/00

(52) U.S. Cl. 707/1

(57) ABSTRACT

When a user selects plural saving after the user has prepared a file with the use of an application loaded from a file system, the application refers to a plural saving information memory device to read thereinto saving conditions needed for plural saving other than saving of an original file. The user designates a plurality of file saving destinations from the application and then sets the saving conditions. Then, when the plural saving is executed, only the file corresponding to the saving conditions is saved at the saving destinations thus set.

### BACKGROUND OF THE INVENTION

1. Field of the Invention

The present invention relates to an apparatus for saving files into a plurality of saving destinations.

2. Description of the Related Art

Owing to the recent technical development of information apparatuses and network information communication fostered by the Internet which has been developed in association therewith, many users have come to open their homepages. In the preparation of the homepage, after the homepage has been hierarchically configured to prepare each page for each hierarchy, the homepage is saved into a specific saving destination and then a link from the top page is prepared. As described above, there has been adopted a conventional system in which when a file was to be saved, the file was always surely saved in to one saving destination under one unique name, so that it was necessary for an implementor of a homepage to save the file for each page into an appropriate saving destination after the file of each page had been prepared. However, in a case that the homepage is constituted by many low-layered pages, after each page has been prepared, files for these many pages should be appropriately copied in sequence and the adjacent pages should be linked together.

That is, in the prior art, the file is saved at one location and the user copies and moves the file as required. For example, in case of saving of public data such as HTML files or the like for the homepage, a file which is under preparation is not made public, but the file is made public in a state that it is finished as its final form. In such a case as mentioned above, conventionally, the file was updated in a working directory to be finished as its final form and thereafter the file was copied (moved) into a public directory.

### SUMMARY OF THE INVENTION

An object of the present invention is to provide a file saving apparatus which is simple in structure and is capable of saving files into a plurality of saving destinations.

A file saving apparatus according to the present invention comprises plural saving designating means for designating file saving destination at a plurality of saving destinations and file saving means for saving the files at the plurality of saving destinations thus designated.

According to the present invention, since the files can be stored at the plurality of saving destinations at one time, failure to copy and move the file or the like can be prevented and hence the working efficiency can be improved in the preparation of the homepage or the like.

### BRIEF DESCRIPTION OF THE DRAWINGS

Next, the present invention will be described in more detail with reference to the accompanying drawings. In the drawings,

FIG. 1 is a diagram showing the structure of a system according to an embodiment of the present invention;

FIG. 2 is a flowchart illustrating a flow of a process relating to the embodiment of the present invention in the system shown in FIG. 1;

FIG. 3 is a flowchart illustrating a flow of a saving condition judging Process;

FIG. 4A and FIG. 4B are diagrams showing examples of file saving information and file saving condition tables;

FIG. 5A and FIG. 5B are diagrams showing other examples of file saving information and file saving condition tables;

FIG. 6A and FIG. 6B are diagrams showing further examples of file saving information and file saving condition tables;

FIG. 7 is a flowchart illustrating a flow of a process of acquiring a plurality of saving destinations;

FIG. 8 is a diagram exemplifying a screen displayed when a plural saving mode is selected;

FIG. 9 is a diagram exemplifying a screen for plural file saving Destination;

FIG. 10 is a diagram exemplifying a screen for a notice of completion of file storage;

FIG. 11 is a diagram showing concrete examples of file definition information used on the screen shown in FIG. 9;

FIG. 12 is a diagram exemplifying a configuration of a plural saving information recording device;

FIG. 13A and FIG. 13B are diagrams exemplifying configurations of a file attribute information storage area and a saving condition storage area;

FIG. 14 is a diagram showing a concrete example of a condition table within the saving condition storage area shown in FIG. 13B;

FIG. 15 is a diagram showing a concrete example of inter-link information of related files; and

FIG. 16 is a diagram illustrating a hardware environment for the information apparatus required when the embodiment of the present invention is implemented as a program.

### DESCRIPTION OF THE PREFERRED EMBODIMENT

In the embodiment of the present invention, a plurality of saving destinations, including a public directory and a plurality of saving conditions, can be designated and upon file saving, files can be saved at a plurality of saving destinations at one time, so that the necessity to copy (move) the file can be eliminated.

In addition, operations conducted after the file has been saved are automated, so that the failure to save the file can be prevented and hence the working efficiency can be improved.

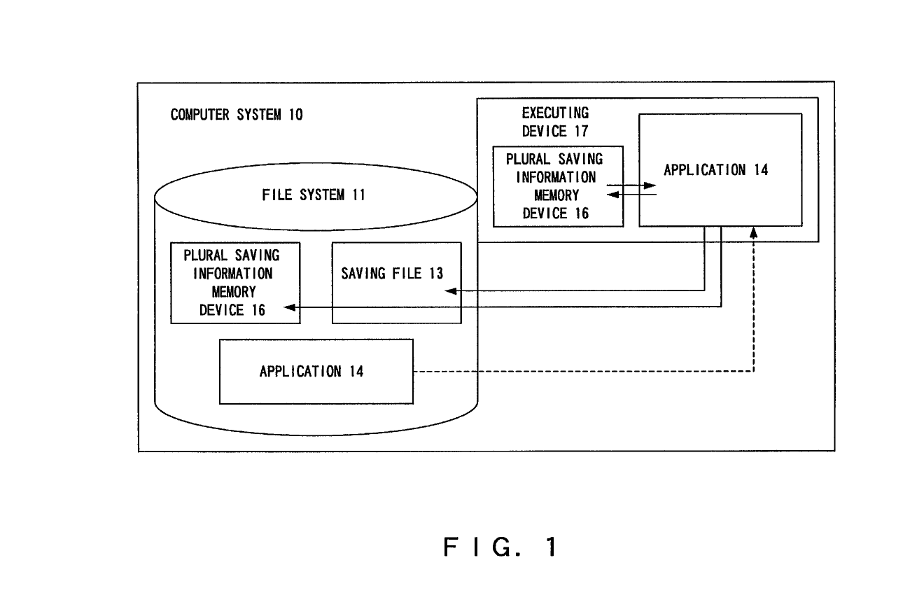

FIG. 1 is a diagram showing the structure of a system according to an embodiment of the present invention.

The system according to this embodiment is constituted by an information apparatus such as a computer 10 or the like. The computer 10 comprises a file system 11 and an executing device 17. In general, an application 14 is stored in the file system 11 before it is started and is loaded to the executing device 17 when it is to be started. The file system 1 is constituted by a hard disk, CD-ROM, DVD, a floppy disk or the like. And, the executing device 17 is constituted by a ROM, a RAM, a CPU or the like.

In addition to the application 14, the executing device 17 includes a plural saving information memory device 16 for storing information at a location the file is to be saved. The plural saving information memory device 16 may be implemented either by providing a dedicated memeory in the executing device 17 to store plural file preserving information therein or by storing the plural file saving information at the file system 11 so as to load the information from the file system 11 to the RAM or the like of the executing device, as required.

The application 14 acquires the plural file saving information from the plural saving information memory device 16 and the file prepared by the application 14 is stored into a plurality of storage locations in the file system 11 as a saved file 13. In this case, the plural file saving information is stored in the plural preserving information memory device 16, which is constituted by the dedicated memeory provided in the executing device 17, or is stored in a specific area 16 within the file system 11.

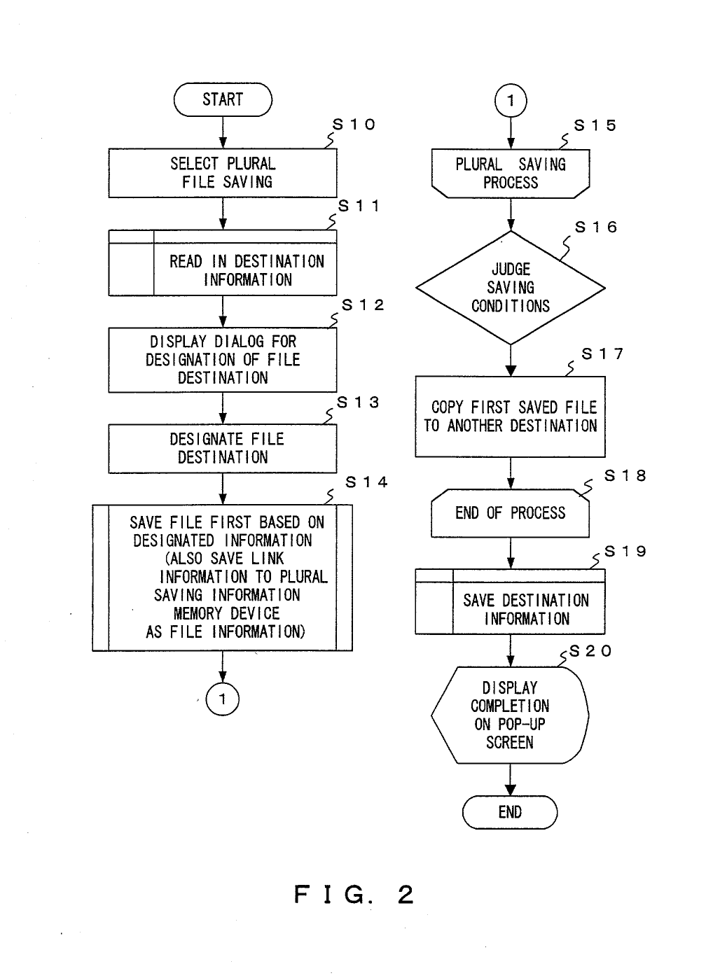

FIG. 2 is a flowchart illustrating a flow of a process relating to the embodiment of the present invention executed in the system shown in FIG. 1.

First, it is supposed that there exists a file to be stored into a plurality of saving destinations in a state that the application is started.

In this case, at step S10, a plural file preserving mode is selected. Then, at step S11, saving destination information is read in. At step S12, dialogue for designating a file saving destination is displayed and, then, at step S13, to which saving destination the file is to be saved is designated by a user.

Then, at step S14, the file is saved in one of the saving destinations designated by the user as the first file based on the information designated by the user at the step S13. At that time, link information to the plural saving information memory device is also saved as file information. Next, a plural saving process is started from step S15.

First, at step S16, a preserving condition (which will be described later) is judged and, at step S17, the first file which has been saved first is copied to another saving destination which is designated by the user. After the first file has been copied in the above mentioned manner to all of the saving destinations designated by the user, the plural saving process is finished at step S18. Then, at step S19, the saving destination information is saved and, at a step S20, completion of the plural saving process is indicated to the user on a pop-up screen to finish the process.

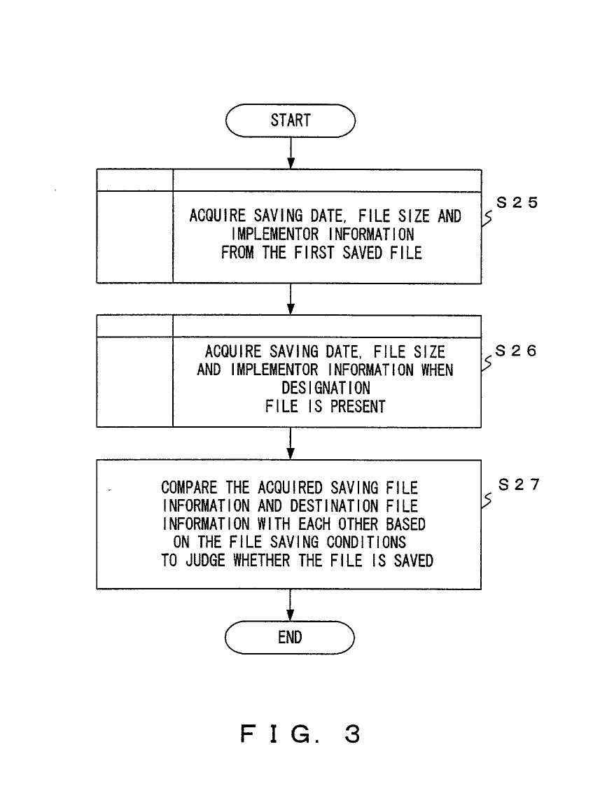

FIG. 3 is a flowchart illustrating a flow of a saving condition judging process.

First, at step S25, saving date, file size and implementor information are acquired from the first file which has been saved first. Then, at step S26, in a case that there exists a saving destination file (that is, in the case of addressing to an existing file), the saving date, the file size and the implmentor information are acquired from this saving destination file.

Then, at step S27, based on the file saving conditions, the saving file information and saving destination file information thus acquired are compared with each other to judge whether the file saving process is executed. As a result, when it is judged that the file saving process is executed, the flow goes to step S17 in FIG. 2. On the other hand, when it is judged that the file saving process is not executed, the process is finished.

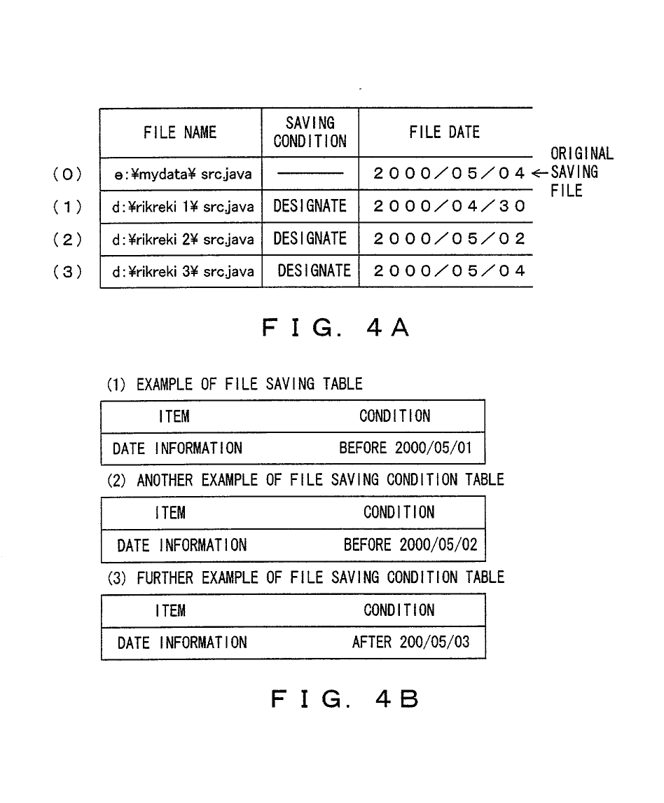

FIGS. 4A and 4B show examples of file saving information and file saving condition tables.

As shown in FIG. 4A, the file name, the preserving condition and the file date are registered as the file saving information. In the case of the example shown in FIG. 4A, an entry (0) of the file saving information indicates the information on the original saving file (the first file which has been described above) and it can be seen that the file date is 2000/05/04. The entries (1) to (3) of this file saving information indicate information on files to be stored at a plurality of saving destinations, and respective file names and file dates are registered and the presence or absence of a designation of a saving condition is registered. In the case of the example shown in FIG. 4A, the saving conditions are designated for all of the plurality of saving files.

FIG. 4B shows the examples of the file saving condition tables and each saving condition table is linked with each entry of the file saving information. For example, the date information is designated in the saving condition table corresponding to the entry (1) of the saving information shown in FIG. 4A as a saving condition item, that is, such a condition is designated that a file dated earlier than 2000/05/01 should be stored. Likewise, the date information is designated in the saving condition table corresponding to the entry (2) of the saving information as an item, that is, such a condition is designated that a file dated earlier than 2000/05/02 should be saved. Then, the date information is designated in the saving condition table corresponding to the entry (3) of the saving information, that is, such a condition is designated that a file dated after 2000/05/02 should be saved.

Accordingly, all of the plurality of saving files of the entries (1) to (3) registered as shown in FIG. 4A conform to the conditions of the saving condition tables in FIG. 4B and hence all of the plurality of saving files are saved.

As has been described above, in a case that a file (such as HTML file of a homepage, a source code file of a program or the like)—presupposing that the same file is always updated—is to be saved, a condition that a file of a certain period (date) is saved is designated.

In this case, it becomes possible to sequentially save respective files which are being worked into a separate directory with no need to use a specific history management tool by designating time, thereby the file can be readily brought back to its original state and problems can be solved at an early stage.

Accordingly, in the case of the example shown in FIG. 4B, files with dates earlier than 2000/05/01, earlier than 2000/05/02 and after 2000/05/03 are saved as the entries (1) d:¥rikreki 1¥src.java, (2) d:¥rikreki2¥src.java, and (3) d:¥rikreki 3¥src.java, respectively, depending on the filing dates under which the files concerned are stored.

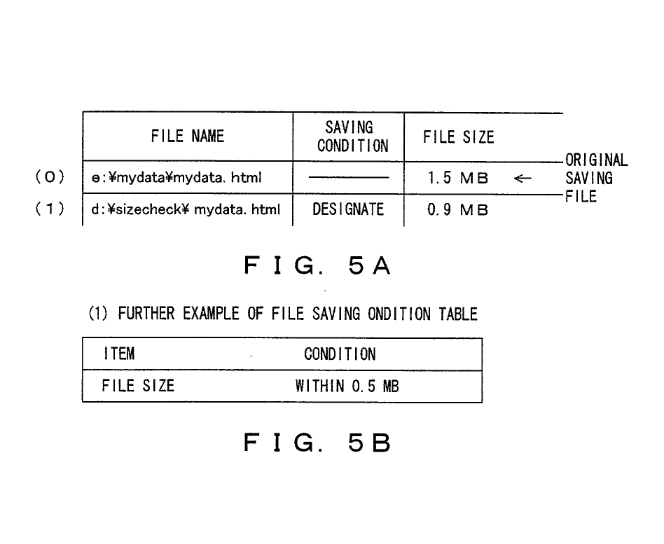

FIGS. 5A and 5B are diagrams showing other examples of file saving information and a file saving condition table.

In FIG. 5A, as contents to be registered, the file name, the saving condition and the file size are designated and the original saving file of the file size of 1.5 MB and a plurality of saving files of the file size of 0.9 MB and for which the saving conditions are designated are registered.

In the saving condition table corresponding to the entry (1) of the saving information in FIG. 5A, the file size is set as an item as shown in FIG. 5B. In this case, such a condition is designated that the file of the file size of 0.5 MB or less should be preserved, which means that the file of the entry (1) in FIG. 5A has a file size of 0.9 MB and hence is not saved.

In the case of preparation of a homepage, it may sometimes occur that the quantity is fixedly limited by a provider with which the user made a contract or that a large-size file should be divided into sections by taking the download time into consideration. Because of a limitation in file size, when an error occurs in the condition, the file concerned is not saved in the directories of the plurality of saving destinations, but error information is messaged. As a result, it becomes possible for the user to recognize the necessity to change the file size when the user intends to preserve the file and hence the possibility of avoiding problems concerning the file size can be increased.

This example shows that, upon plural file storage, the file of (1) d:¥sizecheck¥mydata.html cannot satisfy the saving condition in term of the file size and a message that the file could not be saved is issued at the end of the holding process.

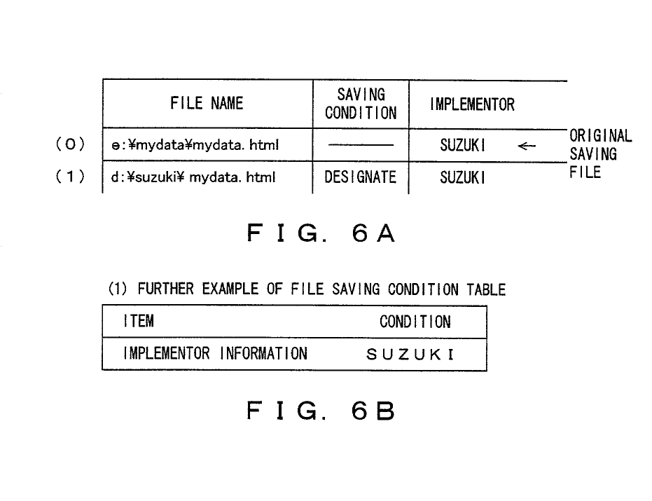

FIGS. 6A and and 6B are diagrams showing further examples of the file saving information and file saving condition table.

In the saving information shown in FIG. 6A, as the contents to be registered, the file name, the saving condition and the implementor are designated, and an original saving file prepared by a person named SUZUKI is registered in the entry (0) and a plurality of saving files also prepared by SUZUKI are registered in the entry (1). Saving conditions are designated for the plurality of saving files.

FIG. 6B shows the example of the file saving condition table, the implementor information is registered as an item and “SUZUKI”, which is the name of the implementor, is registered as a condition. Accordingly, in a case that saving corresponding to the entry (1) of the saving information shown in FIG. 6A is to be conducted, the saving condition table in FIG. 6B is referrenced. In this case, the name of the implementor is SUZUKI and the saving information coincides with the condition in the saving condition table, so that the file of the entry (1) of the saving information is saved.

In a case that a plurality of persons intend to change one common file on a server in the course of group or joint development or the like, file storing destinations are determined in advance for individual implementors in the saving directory, by which file replacement by illegal access can be checked and secure file saving by the implementor can be realized.

In the case of the examples shown in FIGS. 6A and 6B, upon plural file storage, the file of (1) d:¥suzuki¥mydata.html satisfies the condition and hence it is to be saved.

As has been described above, an erroneous operation by the user in the course of routine saving work and a failure to save the file can be prevented by setting the saving condition, by which such advantages can be attained that there is no need for the user to memorize the saving location and the execution time can be shortened.

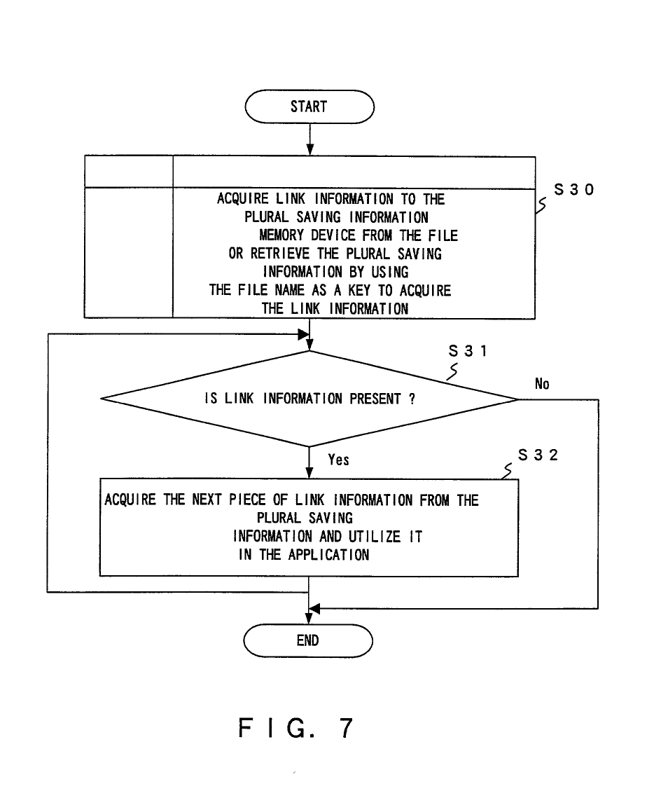

FIG. 7 is a flowchart illustrating a flow of a process of acquiring a plurality of saving destinations.

First, at step S30, link information linking to the plural saving information memory device is acquired from a file or the plural saving information is retrieved by using the file name as a key to acquire the link information. Then, at step S31, it is checked to determine whether the link information is present. When the link information is absent, the process is finished. On the other hand, when the link information is present, the next piece of link information is acquired from the plural saving information at step S32 and it is utilized in the application. Then, at the completion of utilization of the next piece of link information, the flow goes back to the step S31 and the process is repeated as long as the link information is present.

Next, an example of a method of designating plural file saving in which the embodiment of the present invention is used will be described.

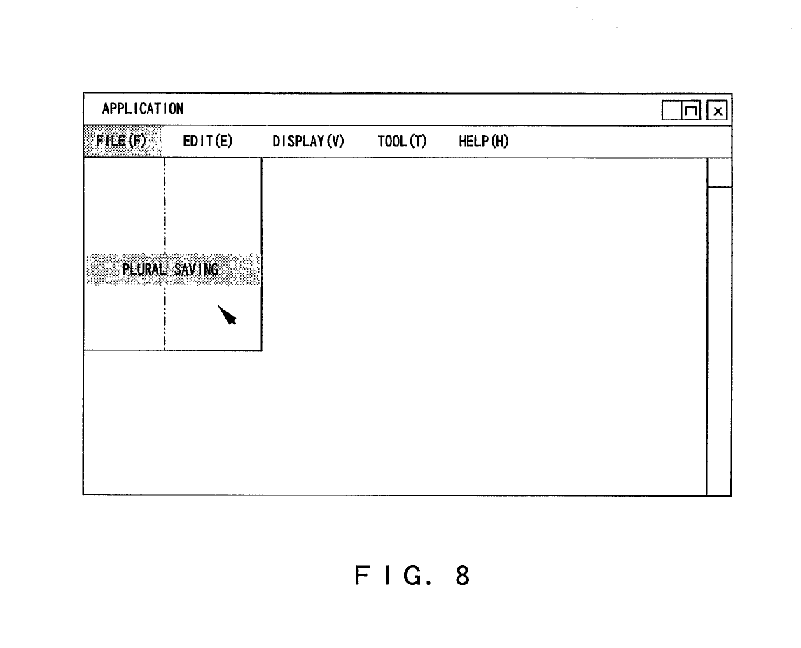

FIG. 8 is a diagram exemplifying a screen displayed when a plural saving mode is selected.

The plural saving mode is configured such that the user can select the mode, for example, from a pull-down menu in a window. In the case of the example shown in FIG. 8, “PLURAL SAVING” is selected from “FILE” in the pull-down menu. Then, a plural saving designation screen is displayed and a holder file name, an attribute of the file to be saved and a saving condition are respectively designated for the plural saving. Then, the file is saved and a result thereof is issued.

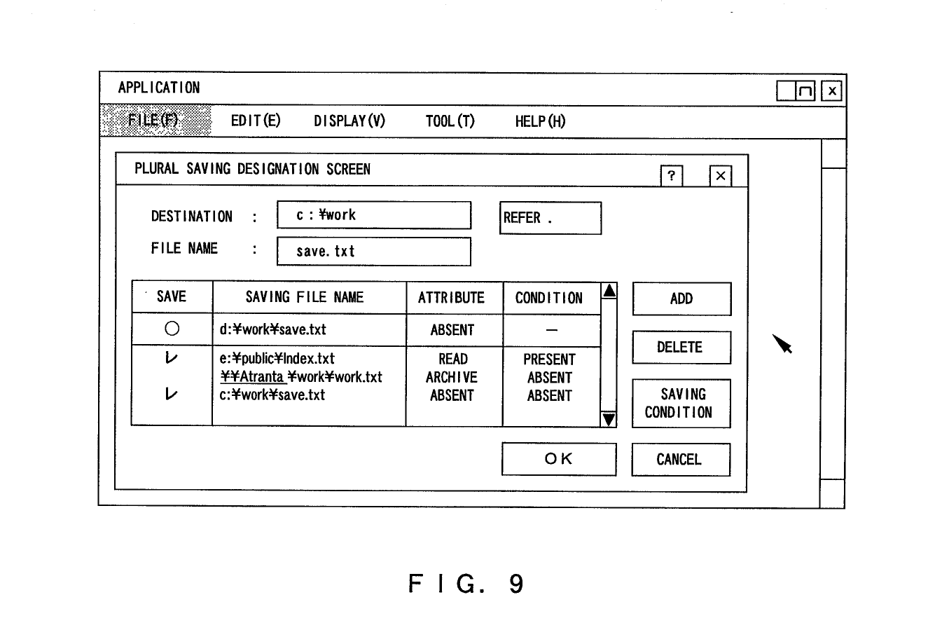

FIG. 9 is a diagram exemplifying a screen for plural file saving designation. On the screen, there exist areas for designating a file saving destination, attributes of the file and saving conditions.

The user designates the saving destination of the original file and the saving name by designating the saving destination and the file name in an upper column on the plural saving designation screen. The dialogue in a lower column on the plural saving designation screen is an area for designation when plural file saving is executed.

In the example shown in FIG. 9, the information on the original file is displayed on this dialogue in the beginning. Next, the saving file name of the file for the plural preservation is designated. This saving file name is described starting with the drive name and together with the saving location. The user enters the dialogue by selecting a button for setting ADD, CANCEL or SAVING CONDITION displayed on the right-hand side of the dialogue to conduct setting operations required for the plural saving. ATTRIBUTE in the dialogue concerned is the one for which a read-only type one, an archival type one or the like which is generally known as the attribute of the file is set and the attribute to be set is displayed when the file is saved. CONDITION means the above mentioned saving condition for judging whether the file is saved by referrencing the saving condition table.

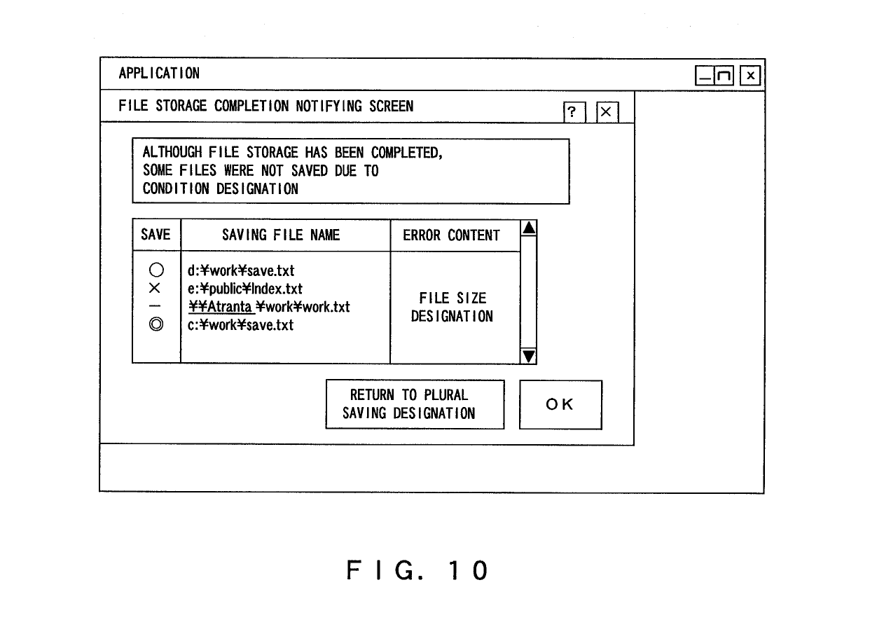

FIG. 10 is a diagram exemplifying a screen for a notice of completion of file storage.

As shown in FIG. 10, the saving file name, marks indicative of whether the file corresponding to this name has been successfully saved and reasons for failure when the file has not been successfully saved are displayed on the screen. The user may go back again to the plural saving designation screen with respect to the file which has not been successfully saved to again make the setting such that the file can be successfully saved or to end the plural file saving process judging that unsuccessful file saving is valid.

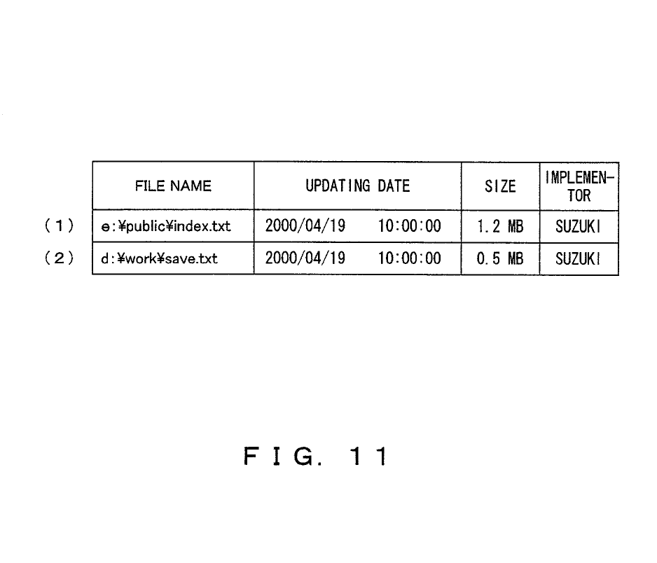

FIG. 11 is a diagram showing concrete examples of file definition information used on the screen shown in FIG. 9.

The file definition information is that defined for each file and the file name, the updating date, the size and the implementor of the file to be pluraly saved are stored therein. Upon the plural saving, the saving condition is examined in accordance with this definition so as to save only a file corresponding to the saving condition. In the example shown in FIG. 10, the file of the entry (1) in FIG. 11 was not saved. The reason lies in the fact that the size of the file is larger than the value set in the saving condition. For example, in the saving condition table, the file size is set to be 1MB or less as the saving condition. In a case that the saving condition as mentioned above is set, the file of the entry (1) in FIG. 11 is 1.2 MB in size and hence is not saved.

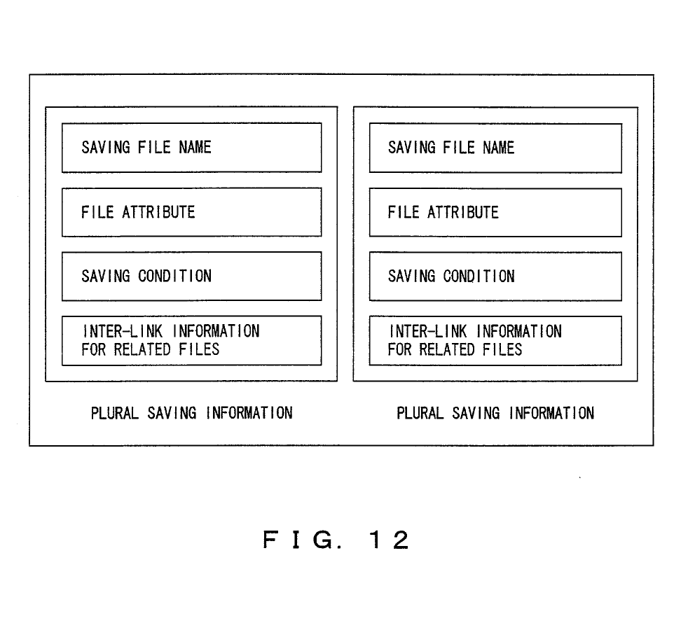

FIG. 12 is a diagram exemplifying a configuration of a plural saving information recording device.

There exists a plural file saving information memory device in the filing system, as shown in FIG. 12, for the plural file saving designation screen shown in FIG. 9. In this connection, it is to be noted that although the word “device” is used, this may simply be a memory area for storing information. The plural file saving information memory device is provided with a sufficient number of areas for storing all of file saving destinations, file attributes and saving conditions which would constitute plural file saving information. In this example, the file saving destinations, the file attributes, the saving conditions and inter-link information are stored as the plural file saving information. In the plural file saving information memory device, a file attribute is assigned to the saving destination of the file corresponding to the information thus stored, and when the file conforms to the saving condition, the file is saved, and then the file thus saved is copied tracing the next piece of file saving information based on the link information and the file thus copied is saved as the same file as the above.

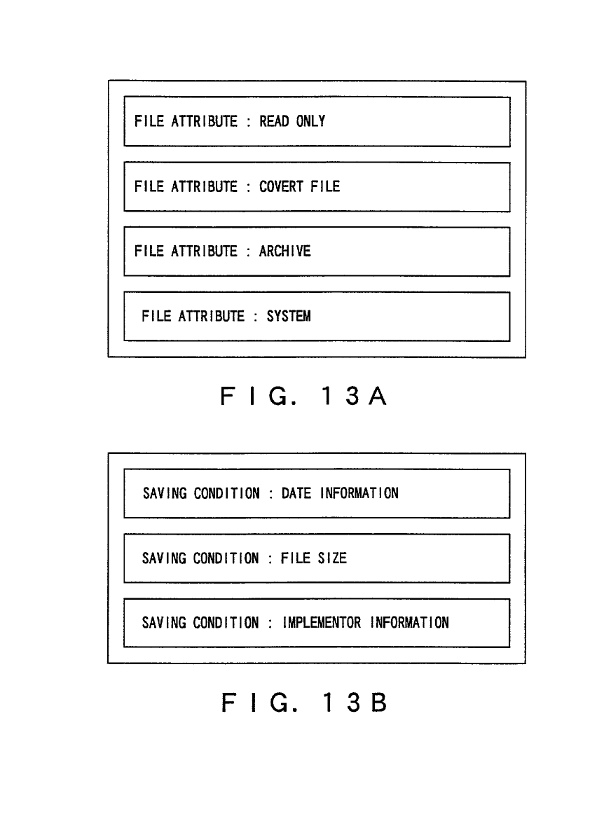

FIGS. 13A and 13B are diagrams exemplifying configurations of file attribute information storage areas and a saving condition storage region.

FIG. 13A exemplifies the file attribute storage area. In this example, the area is obtained such that READ-ONLY, COVERT FILE, ARCHIVE and SYSTEM can be set as the file attributes. FIG. 13B exemplifies the saving condition storage area. In this example, the area is constructed such that the holding conditions in which DATE INFORMATION, FILE SIZE and IMPLEMENTOR INFORMATION are used as keys can be set.

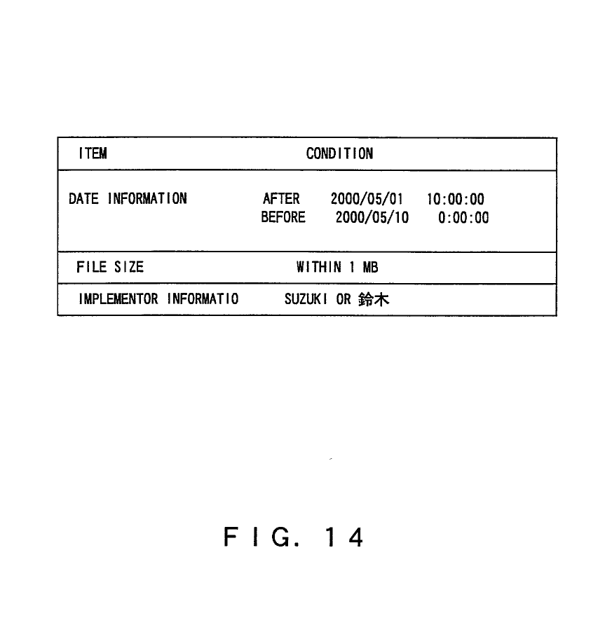

FIG. 14 is a diagram showing a conceret example of a condition table within the saving condition storage area shown in FIG. 13B.

The concrete example shown in FIG. 14 is configured such that DATE INFORMATION, FILE SIZE and IMPLEMENTOR INFORMATION can be registered as items. In the case of DATE INFORMATION, such a concrete condition is set that a file of a date after 2000/05/01, 10:00:00 and earlier than 2000/05/10, 0:00:00 should be saved. In addition, such conditions are also set such that when the file size is 1 MB or less and the implementor is “SUZUKI” or, in Chinese characters, “ [symbol] ” the file should be saved.

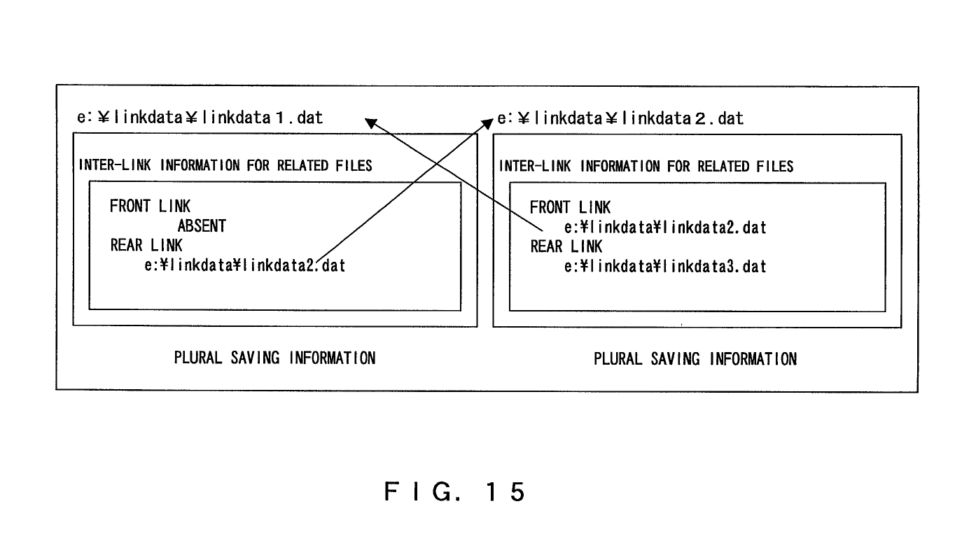

FIG. 15 is a diagram showing a concrete example of inter-link information of related files.

The inter-link information is the one for managing link information linking together a plurality of files designated to be saved when plural saving is designated and is set when the files are to be saved.

FIG. 15 shows the example of storage information when the plural saving information is treated as one file. In order to acquire the plural file saving information, the inter-link information indicative of the plural saving information is stored. That is, in the case of the example shown in FIG. 15, when a file such as “e:¥linkdata¥linkdata1.dat” is pluraly saved, “e:¥linkdata¥linkdata2.dat” is related thereto as a file related to the above such that the related files which have been plurally saved can be readily acquired. Likewise, as files related to the file “e:¥linkdata¥linkdata2.dat”, “e:¥linkdata¥linkdata1.dat” and “e:¥linkdata¥linkdata3.dat” can be readily acquired. Accordingly, when a homepage or the like is prepared in the application, the related files can be readily found and, in addition, failure to update a file which should be updated can be prevented.

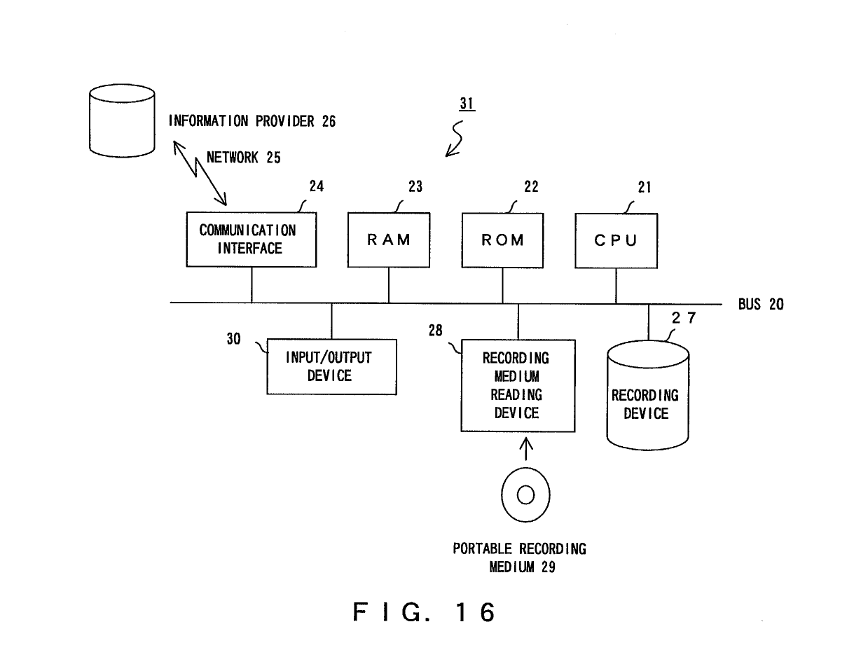

FIG. 16 is a diagram illustrating a hardware environment of an information apparatus needed when the embodiment of the present invention is implemented as a program.

The information apparatus 31 comprises a CPU 21, a ROM 22, a RAM 23, a communication interface 24, a recording device 27, a recording medium reading device 28, and an input/output device 30 which are inter-connected via a bus 20. The program for implementing the embodiment of the present invention can be stored in the ROM 22. Although, the ROM 22 is typically adapted to store a basic program for realizing data exchange between the input/output device 30, consisting of a display, a mouse, a keyboard and the like such as BIOS or the like, and the CPU 21, the program for implementing the embodiment of the present invention may be stored in the CPU 21 so as to use the information apparatus 31 as a special purpose apparatus. In general, the program concerned in the embodiment of the present invention is recorded in the recording device 27, such as a hard disk or the like, and is modified and stored by the CPU 21 in the RAM 23 so as to be brought into an executable state.

As an alternative, the program concerned maybe stored in a portable recording medium, such as the CD-ROM, the DVD, the floppy disk or the like, and then is read by a recording medium reading device 28 so as to be stored by the CPU in the RAM 23 such that it is brought into the executable state. Typically, the program concerned, which is read out from the portable recording medium 29, is installed in the recording device 27 to be executed when needed.

As another alternative, the program concerned may be executed by using the communication interface 24 of the information apparatus 31 to connect the information apparatus to an information provider 26 via a network 25 so as to download the program concerned from the information provider 26. Instead, it is also possible to execute the program concerned under the network environment in a case that the network 25 is constituted like a LAN. In addition, in a case that the file is to be saved in the plurality of saving destinations, it is also possible to use the database of the informtion provider 26 as its saving destination.

Although the present invention has been described based on the specific embodiment thereof, it is apparent that this embodiment is merely an example and the present invention can be readily modified in a variety of ways within the scope of the present invention by a person skilled in the art.

According to the invention, the file processing operations, such as file copying operation, file moving operation and other operations which have been conventionally conducted after the file has been saved, are automated, by which the working efficiency is improved.

What is claimed is:

1. A file saving apparatus comprising:
a plural saving designating unit designating saving destinations in which a file should be saved at a plurality of saving destinations; and
a file saving unit saving said file in said plurality of saving destinations thus designated.

2. The file saving apparatus according to claim 1, wherein said plural saving designating unit designates a plurality of file saving conditions.

3. The file saving apparatus according to claim 2, wherein said file saving conditions can be designated for each of said plurality of saving destinations.

4. The file saving apparatus according to claim 2, wherein said file saving conditions include designation of a term for which said file has been prepared.

5. The file saving apparatus according to claim 2, wherein said file saving conditions include designation of a size of said file.

6. The file saving apparatus according to claim 2, wherein said file saving conditions include designation of an implementor of said file.

7. The file saving apparatus according to claim 1, wherein said plural saving designating unit saves at least one file unconditionally.

8. The file saving apparatus according to claim 1, further comprising:
a link information storing unit storing inter-link information for the files saved at said plurality of saving destinations.

9. A file saving method comprising:
performing designation of saving destinations in which a file should be saved at a plurality of saving destinations; and
saving the files at said plurality of saving destinations thus designated.

10. A recording medium which is readable through an information apparatus, for storing a program for implementing, in the information apparatus, a file saving method comprising:
performing designation of preserving destinations into which a file should be saved at a plurality of saving destinations; and
saving the file at said plurality of saving destinations thus designated.
